(19) United States
(12) Patent Application Publication
(10) Pub. No.: US 2015/0017622 A1
(43) Pub. Date: Jan. 15, 2015

(54) HUMAN BODY MOVEMENTS CONTROL USING DIGITAL COMPUTER CONTROLLED LIGHT SIGNALS-WRITTEN DANCE LANGUAGE

(71) Applicant: Qussay Abdulatteef Jasim Al-Ani, Manama (BH)

(72) Inventor: Qussay Abdulatteef Jasim Al-Ani, Manama (BH)

(21) Appl. No.: 13/941,394

(22) Filed: Jul. 12, 2013

(51) Int. Cl. G09B 19/00

(52) U.S. Cl. CPC G09B 19/003
USPC 434/257

(57) ABSTRACT

A high definition (HD) enabled digital light display system adaptable to allow an individual or group to participate in a dance, a march, a celebration, a sport, a game, or other activity requiring body movements is presented. The system comprises a display unit having a plurality of computer designed light signals adaptable to create different light arrangements. A digital plasma control board is integrated into the display unit and includes a plurality of microcontrollers programmed with a display program that utilizes a computer programmed alphabet language. The computer programmed alphabet language includes a plurality of display codes to enable the light module to display a plurality of cartoon animations and a plurality of alphabetical letters on a digital display screen. The cartoon animations and the alphabetical letters enable the individual to perform at least one body movement of the dance, march, celebration, sport, or game.

### TECHNICAL FIELD OF THE DISCLOSURE

The present embodiment is related in general to digital light systems and in particular to a high definition (HD) enabled digital light system that utilizes a computer programmed alphabet language adaptable to display cartoon animations and display codes on a digital display screen for assisting an individual or group to perform synchronized body movements during dances, marches, sports and other games.

### DESCRIPTION OF THE RELATED ART

A wide variety of training devices have been developed in the art. These training devices provide proper guidance and instructions to individuals and groups to help them to learn synchronized dancing. However, it is very difficult for kids and people having disabilities such as deafness to learn dance and other art forms utilizing these conventional training devices. A lot of teaching effort and time are required to train children and the disabled. The deaf and similarly disabled people require years of practice to learn correct body position associated with various art forms.

With the rapid advancement of technology, specially designed training devices have been developed. These devices incorporate music, video, text inputs and light systems to assist children and the disabled in performing sports and other cultural activities. For example, U.S. Pat. Publication No. 2010/0090621 to Baker and published on Apr. 15, 2010, provides a method of using lights and a light system for teaching dance, particularly to students with hearing impairments. The method of dance instruction includes a light bar having a plurality of first lights and second lights. The first and second lights are visually distinguishable. The first lights are turned on and off to display a pre-selected time signature pattern, and the second lights of the light bar are turned on and off to display a pre-selected and count time signature pattern. Even so, this light system displays only light signals which are insufficient to perform the dance.

U.S. Pat. No. 6,116,908 issued to Takai on Sep. 12, 2000, provides a dance training device that permits a user to dance without substantial need to concentrate on understanding the order of foot positions from a complex diagram, but rather by immediately understanding the foot positions, thus permitting the user to focus his/her concentration on learning the foot positions, resulting in efficient dance instruction. However, this device has a very complex construction. Further, the user finds it difficult to learn the complex training data used in this dance training device.

U.S. Pat. No. 4,702,475 issued to Elstein on Oct. 27, 1987, provides a system and technique for accelerated reaction training of a person by a training program in which an array of lights is positioned visibly in front of the person, with each light signifying a different particular movement pattern to be executed by the person in a given amount of time. Even though this system trains an individual to play a game utilizing an array of light, this light system is not suitable for the deaf since the individual is required to listen an audio instruction to play the game.

Therefore, there is a need for a device that would assist the deaf and disabled people to perform body movements in dance, games and marches. Such a device would be reliable and simple in construction.

### SUMMARY OF THE DISCLOSURE

To minimize limitations found in the prior art, and to minimize other limitations that will be apparent upon the reading of the specifications, a preferred embodiment of the present invention provides a high definition (HD) enabled digital light display system to assist an individual or group to perform synchronized body movements using visual display of light signals. The HD digital light display system utilizes a display program adaptable to display cartoon animations and alphabetical letters for assisting the individual to participate in dance, march, sports and games without the need for music or any audio instruction.

The HD digital light display system comprises a display unit. The display unit includes an attachment member to attach the display unit on a desired location. The display unit includes a light module configured to create a plurality of computer designed light signals. The plurality of computer designed light signals is adaptable to create different light arrangements. The light arrangements may include cartoon animations and the alphabetical letters which enable the individual or group to perform the body movements. Each cartoon animation corresponds to each body movement of a dance or game. The light module includes a plurality of light emitting diodes (LEDs) to display the cartoon animations and alphabetical letters. The cartoon animations and the alphabetical letters are displayed on a digital display screen located at a front portion of the display unit. The visual display of the cartoon animations and the alphabetical letters helps the individual to perform a plurality of body movements of a dance or a march without having to listen to any music or audio instruction.

The display unit is integrated with a digital plasma control board. The digital plasma control board includes a plurality of microcontrollers programmed with a display program. The display program utilizes a computer programmed alphabet language having a plurality of display codes to display the different light arrangements. The plurality of display codes includes the alphabetical letters. The dancers or dance trainer can create a new dance utilizing the computer programmed alphabet language. Each body movement is associated with each alphabetical letter. The dance trainer assigns each alphabetical letter to each body movement of the dance or any cultural event. Depending on the alphabetical letters, the cartoon animations associated with the body movements are displayed on the digital display screen. In order to perform a dance or a march, the dancers or marchers are instructed by the trainer to perform the at least one body movement when corresponding cartoon animation is displayed on the digital display screen. All the body movements and the corresponding alphabetical letters are taught to the dancers by the trainer. The HD digital light display system is mainly intended for deaf dancers or people having hearing impairment. The display system enables these disabled people to perform each body movement of a dance by simply watching the visually displayed cartoon animations and the display codes. The plurality of body movement includes “left hand up”, “right hand up”, “left leg up”, “right leg up” and so on.

A remotely located computer control server or fully controlled computer may monitor and control the display unit and the digital plasma control board. The computer control server and the digital plasma control board may be in wireless communication with each other.

One objective of the invention is to provide a computer controlled HD digital light display system adaptable to allow a person to perform a plurality of body movements.

A second objective of the invention is to provide a computer controlled HD enabled digital light display system that allows a person having hearing impairment to participate in a dance, a march, games, and any other activity that requires body movements by watching the visually displayed alphabetical letters and cartoon animations.

A third objective of the invention is to provide a HD enabled digital light display system that enables an individual to perform a dance or any cultural event without listening to a music or any audio instruction.

These and other advantages and features of the present invention are described with specificity so as to make the present invention understandable to one of ordinary skill in the art and for the first time dances can be written in the new dance language and can be repeated ten years later.

### BRIEF DESCRIPTION OF THE DRAWINGS

Elements in the figures have not necessarily been drawn to scale in order to enhance their clarity and improve understanding of these various elements and embodiments of the invention. Furthermore, elements that are known to be common and well understood to those in the industry may not be depicted in order to provide a clear view of the various embodiments of the invention. Thus, the drawings are generalized in form in the interest of clarity and conciseness.

FIG. 1 is a perspective view of a high definition (HD) enabled digital light display system of an embodiment of the present invention; and

FIGS. 2 and 3 illustrate the HD digital light display system of an embodiment of the present invention in use.

### DETAILED DESCRIPTION OF THE INVENTION

In the following discussion that addresses a number of embodiments and applications of the present invention, reference is made to the accompanying drawings that form a part hereof, and in which is shown by way of illustration specific embodiments in which the invention may be practiced. It is to be understood that other embodiments may be utilized and changes may be made without departing from the scope of the present invention.

Various inventive features are described below that can each be used independently of one another or in combination with other features. However, any single inventive feature may not address any of the problems discussed above or only address one of the problems discussed above. Further, one or more of the problems discussed above may not be fully addressed by any of the features described below. Embodiments of the present invention will now be described, by way of example, with reference to the accompanying drawings. While particular embodiments have been described, it will be understood that various modifications may be made without departing from the scope of the invention.

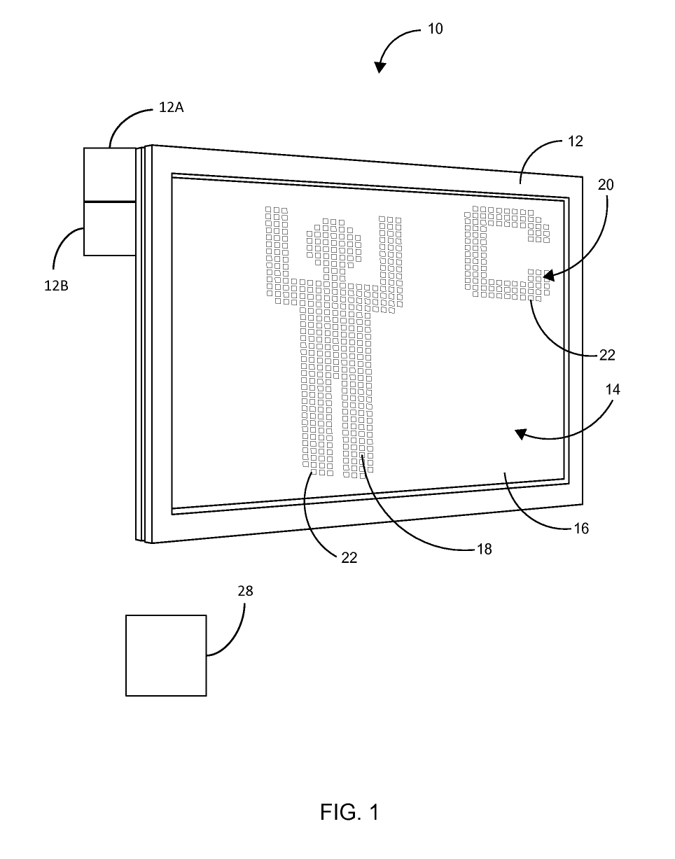

FIG. 1 shows a perspective view of a high definition (HD) enabled digital light display system 10 adaptable to enable an individual or group to perform dances, marches and sports utilizing a visual display of a plurality of computer designed light signals. The HD enabled digital light display system 10 generally comprises a display unit 12. The display unit 12 includes an attachment member (not shown) for attaching the display unit 12 on a desired location. A light module 12A configured to create the plurality of computer designed light signals is integrated into the display unit 12. It will be appreciated that other types of displays may be used with the HD enabled digital light display system 10.

The HD enabled digital light display system 10 further comprises a digital display screen 16 located at a front portion 14 of the display unit 12. The plurality of computer designed light signals is adaptable to create different light arrangements. The light arrangements may include cartoon animations 18 and alphabetical letters 20. The plurality of computer designed light signals may range from a hundred to a maximum number. The digital display screen 16 is designed to display the different light arrangements. The display unit 12 is integrated with a digital plasma control board 12B. The digital plasma computer control board 12B includes a plurality of microcontrollers installed with a display program. The plurality of microcontrollers ranges from hundreds to a maximum number. The display program utilizes a computer programmed alphabet language that features a plurality of display codes for displaying the different light arrangements on the digital display screen 16. The plurality of display codes includes alphabetical letters. Each body movement is associated with each alphabetical letter. As shown in FIG. 1, the cartoon animation shows an individual with the both hands in a raised position. According to the computer programmed alphabet language, the display code for this particular body movement is “C” 20. The alphabetical letter “C” 20 corresponding to this body movement is also displayed on the digital display screen 16. It will be appreciated that non-alphabetical characters, such as numerals, may be used instead of or in addition to the alphabetical characters 20.

The cartoon animation 18 illustrated in FIG. 1 resembles a human being. This helps an individual, mainly a deaf or a child to perform the same body movement as displayed in the digital display screen 16. The alphabetical letter “C” 20 and the cartoon animation 18 are displayed with the plurality of LED lights 22. A dance trainer can create different dances utilizing the computer programmed alphabet language. Each body movement is associated with each alphabetical letter. The dance trainer assigns each alphabetical letter to each body movement of a dance, a march or any cultural event. Depending on the alphabetical letters, the cartoon animation 22 associated with a particular body movement is displayed. All the body movements and the corresponding alphabetical letters are taught by the trainer to the dancers. The plurality of body movements may include, among others, “left hand up”, “right hand up”, “left leg up”, “right leg up” and so on. The computer programmed alphabet language and the display codes can be applied for different dances, games and sports. The HD enabled digital light display system 10 enables the individual to perform a dance or any cultural event without listening to music or any audio instruction. Other such activities may include military and police cadet marches, school celebrations, sports half-time shows, or other activity requiring body movements. Music may be played for the benefit of non-hearing impaired people who are present.

A remotely located computer control server 28 may control and monitor the display unit 12 and the digital plasma control board 12B. The computer control server 28 and the digital plasma control board 12B may be in wired or wireless communication with each other. The computer control server 28 enables the plurality of computer designed light signals to flash at different frequencies on the digital display. The flashing of the plurality of computer designed light signals makes the dancing session more interactive.

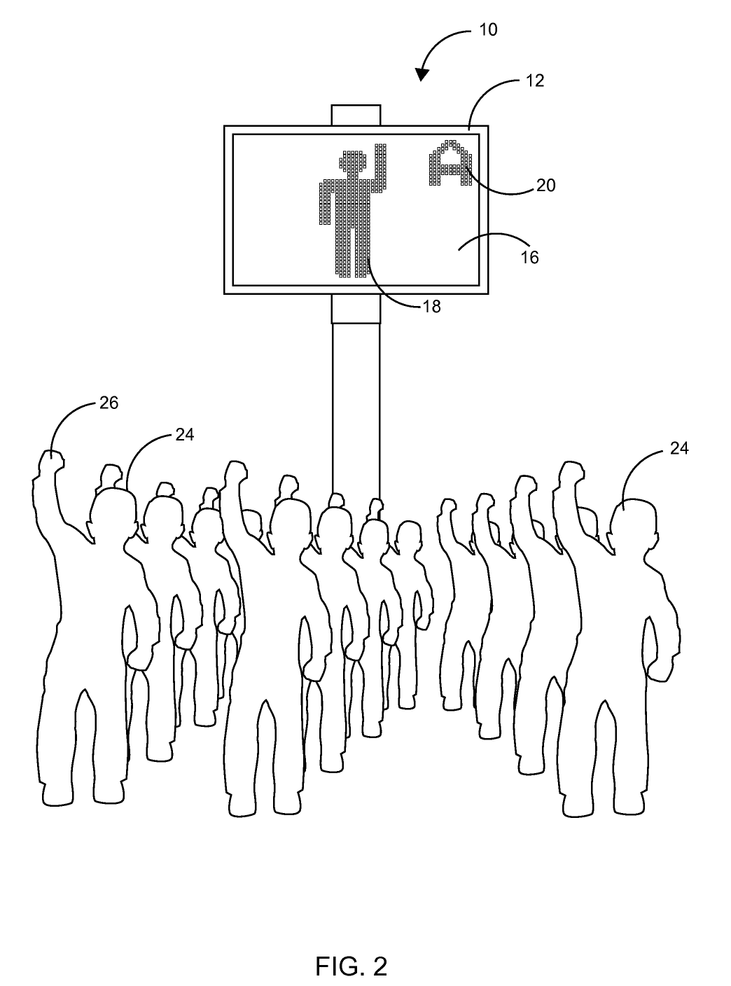

FIG. 2 shows a group of dancers 24 practicing a dance utilizing the HD enabled digital light display system 10 of the present invention. This cartoon animation 18 and the corresponding alphabetical letter “A” 20 according to the computer programmed alphabet language are displayed on the digital display screen 16. When the dancers 24 see the alphabetical letter “A” 20 and the corresponding cartoon animation 18, the dancers 24 raise their left hand 26.

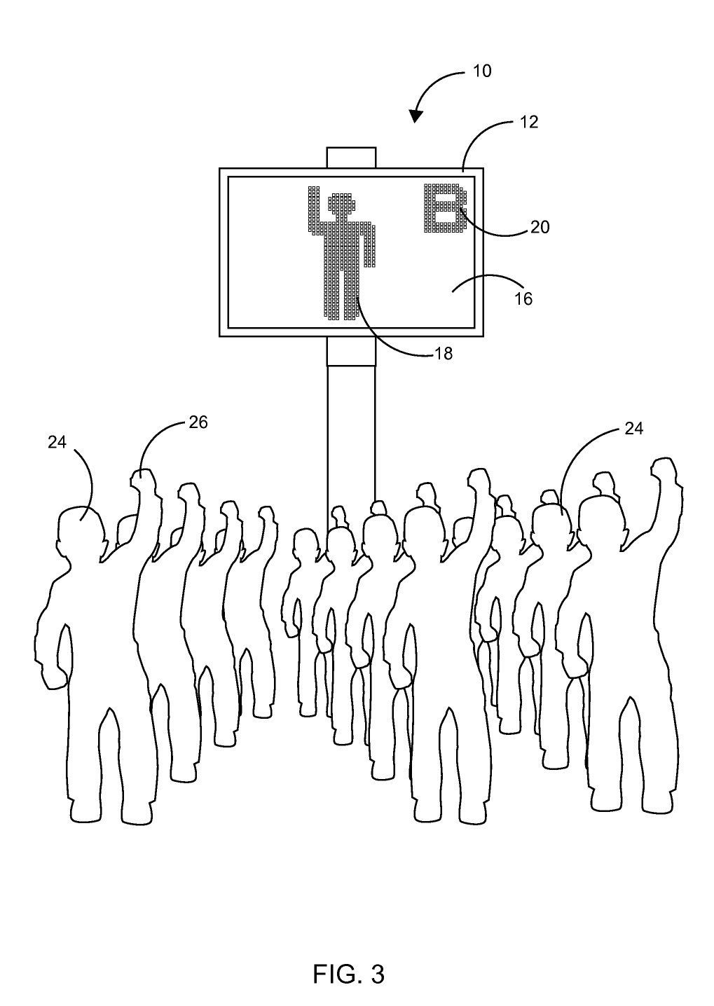

FIG. 3 illustrates the cartoon animation 18 with the right hand in a raised position. The alphabetical letter “B” 20 corresponding to this particular body movement is also shown in the digital display screen 16. When the dancers 24 see the cartoon animation 18 on the digital display screen 16, the dancers 24 raise their right hand 26. The different body movements and their corresponding display codes are taught to the dancers 24 by the trainers. If the dancer 24 forgets a body movement, the display of the cartoon animation 18 helps the dancer 24 to remember the correct body movement. When the HD enabled light display system 10 is utilized by non-deaf people, military marchers or people without any disabilities, background music can played for the benefit of these performing people and also for the audience who are watching the performance.

### EXAMPLES

| Body Movement | Display Code |
|---|---|
| Left Hand Up | A |
| Right Hand Up | B |
| Both hands Up | C |
| Right Leg Up | D |
| Hips Move Left | E |

The above table is an example of a few representative body movements and their corresponding display codes. As illustrated in the table, the display code for the body movement “Left hand up” is “A”, the display code for the body movement “right hand up” is “B”. For the body movement “both hands up” is “C”, and that of “right leg up” is D. Finally, the “E” is the display code for the body movement “Hips move left”. It will be appreciated that any number of body movements and corresponding display codes my be used.

The foregoing description of the preferred embodiment of the present invention has been presented for the purpose of illustration and description. It is not intended to be exhaustive or to limit the invention to the precise form disclosed. Many modifications and variations are possible in light of the above teachings. It is intended that the scope of the present invention not be limited by this detailed description, but by the claims and the equivalents to the claims appended hereto.

We claim:

1. A high definition (HD) enabled digital light display system, comprising:
a display unit;
a light module integrated into the display unit and configured to create a plurality of computer designed light signals;
a digital display screen coupled to receive the computer designed light signals from the light module and located at a front portion of the display unit, the digital display screen configured to display different light arrangements according to the received the plurality of computer designed light signals;
a digital plasma control board integrated into the display unit, the digital plasma control board being HD enabled and including a plurality of microcontrollers programmed with a computer programmed alphabet language, the computer programmed alphabet language utilizing a plurality of display codes directing the light module to display a plurality of cartoon animations and the plurality of display codes on the digital display screen; and
a computer control server coupled to the display unit and the digital plasma control board and configured to control and monitoring the display unit and the digital plasma control board.

2. The HD enabled digital light display system of claim 1, wherein the plurality of display codes and the plurality of cartoon animations displayed on the digital display screen provide a visual representation of at least one body movement.

3. The HD enabled digital light display system of claim 1, wherein each of the plurality of cartoon animations is associated with at least one of the plurality of display codes.

4. The HD enabled digital light display system of claim 1, wherein each of the plurality of display codes is associated with the at least one body movement.

5. The HD enabled digital light display system of claim 1, wherein the plurality of display codes may include alphabetical letters.

6. The HD enabled digital light display system of claim 1, wherein the light module may include a plurality of light emitting diodes (LEDs) to generate the plurality of computer designed light signals.

7. The HD enabled digital light display system of claim 1, wherein the computer control server and the digital plasma control board are in wireless communication with each other.

8. The HD enabled digital light display system of claim 1, wherein the plurality of computer designed light signals flash on the digital display screen at different frequencies.

9. The HD enabled digital light display system of claim 8, wherein the computer control server directs the plurality of computer designed light signals to flash at different frequencies.

10. The HD enabled digital light display system of claim 1 wherein the body movements are associated with at least one of various arts, sports and cultural events.

11. The HD enabled digital light display system of claim 1, wherein the computer programmed alphabet language and the display codes are applicable to different marches, dances, games, celebrations, and sports.
